(19) United States
(12) Patent Application Publication
(10) Pub. No.: US 2024/0251713 A1
(43) Pub. Date: Aug. 1, 2024

(54) SELF-PROPELLED AGRICULTURAL HARVESTER

(71) Applicant: CLAAS Selbstfahrende Erntemaschinen GmbH, Harsewinkel (DE)

(72) Inventors: Niklas Löffler, Hohentengen (DE); Tobias Deufel, Meßkirch-Menningen (DE)

(73) Assignee: CLAAS Selbstfahrende Erntemaschinen GmbH, Harsewinkel (DE)

(21) Appl. No.: 18/428,061

(22) Filed: Jan. 31, 2024

(30) Foreign Application Priority Data
Jan. 31, 2023 (DE) 102023000284.4
Jan. 31, 2023 (DE) 102023102282.2
Jan. 31, 2023 (DE) 102023102283.0
Jan. 31, 2023 (DE) 102023102284.9

(51) Int. Cl. A01D 43/08

(52) U.S. Cl. CPC A01D 43/085; A01D 43/086

(57) ABSTRACT

A self-propelled agricultural harvester, such as a forage harvester, is disclosed. The harvester has at least one post-acceleration unit for the variable acceleration of harvested material and a transfer device downstream from the post-acceleration unit for ejecting the harvested material into a loading container. The width of a harvested material passage gap of the post-acceleration unit may be adjusted using a gap-changing device for the variable acceleration of the harvested material. A control device may evaluate data generated by a swath detection device with the data indicative of properties of the harvested material. Based on the evaluation, the control device may generate control signals to control the gap-changing device, thereby for adjusting the width of the harvested material passage gap.

### CROSS REFERENCE TO RELATED APPLICATION

This application claims priority under 35 U.S.C. § 119 to German Patent Application No. DE 10 2023 102 282.2 (filed Jan. 31, 2023), German Patent Application No. DE 10 2023 102 283.0 (filed Jan. 31, 2023), German Patent Application No. DE 10 2023 000 284.4 (filed Jan. 31, 2023), and German Patent Application No. DE 10 2023 102 284.9 (filed Jan. 31, 2023), the entire disclosure of each of which is hereby incorporated by reference herein in their entirety.

### TECHNICAL FIELD

The present invention relates to a self-propelled agricultural harvester and to a method for operating a self-propelled agricultural harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 1 380 204 A1, incorporated by reference herein, discloses a self-propelled agricultural harvester (interchangeably termed a self-propelled harvester) that may comprise a forage harvester. The forage harvester may comprise at least one post-acceleration unit for the variable acceleration of harvested material and with a transfer device downstream from the post-acceleration unit for ejecting the harvested material into a loading container. For the variable acceleration of the harvested material, the width of a harvested material passage gap of the post-acceleration unit, which may be formed between the post-acceleration unit and a wall of a conveying channel opposite it, may be adjusted using a gap-changing device. This may influence the engagement intensity of the post-acceleration unit on the harvested material. A control device may be assigned to the gap-changing device, which may control the gap-changing device via a generated control signal. For this purpose, EP 1 380 204 A1 discloses adjusting the width of the harvested material passage gap as a function of the harvested material throughput, which may be determined using sensors for measuring the moisture, the density and the speed of the harvested material. The sensors may be arranged inside the harvester along the crop conveyor section between the intake unit and the transfer device.

Further, DE 10 2020 002 864 A1 describes an agricultural harvester designed as a forage harvester with at least one post-acceleration unit for the acceleration of harvested material and with a transfer device downstream from the post-acceleration unit for ejecting the harvested material into a loading container. During grass harvesting, the post-acceleration unit is used to accelerate the harvested material, in that the post-acceleration unit is in an acceleration position in which the post-acceleration unit projects into the conveying channel.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic representation of an agricultural harvester designed as a self-propelled forage harvester in a side view;

FIG. 2 illustrates a schematic representation of the harvester according to FIG. 1 with an attachment designed as a pick-up for picking up a swath;

FIG. 3 illustrates a schematic view of a harvesting situation of the harvester according to FIG. 2 from above;

FIG. 4 illustrates a schematic and exemplary side view of a post-acceleration unit of the harvester in a position with minimum width of a harvested material passage gap; and

FIG. 5 illustrates a schematic and exemplary side view of the post-acceleration unit according to FIG. 4 in a position with maximum width of the harvested material passage gap.

### DETAILED DESCRIPTION

As discussed in the background, EP 1 380 204 A1 discloses adjusting the width of the harvested material passage gap as a function of the harvested material throughput, which may be determined using sensors (which may be arranged inside the harvester along the crop conveyor section between the intake unit and the transfer device) for measuring the moisture, the density and the speed of the harvested material. The reaction to changes in the harvested material flow may therefore always be delayed. In addition, the increasing driving speed, which may be accompanied by an increase in the area output, may lead to a further reduction in the reaction time to changing harvesting conditions or harvesting situations during the harvesting process.

Further, DE 10 2020 002 864 A1 discloses that during grass harvesting, the post-acceleration unit is used to accelerate the harvested material, in that the post-acceleration unit is in an acceleration position in which the post-acceleration unit projects into the conveying channel. During corn harvesting, the post-acceleration unit may be in a passive position in which the post-acceleration unit is extended out of the conveying channel and acts as a fan. In the passive position, the post-acceleration unit may hardly interact mechanically with the harvested material. Switching between the acceleration position and the passive position may also take place depending on the presence of a conditioning device for processing corn kernels.

Thus, in one or some embodiments, an agricultural harvester and a method for operating an agricultural harvester are disclosed that is configured for an improved adaptation of the adjustment of the post-acceleration unit to changing harvesting conditions or harvesting situations.

In one or some embodiments, a self-propelled agricultural harvester, such as a forage harvester, is disclosed. The self-propelled agricultural harvester has at least one post-acceleration unit configured for the variable acceleration of harvested material and a transfer device arranged downstream from the post-acceleration unit that is configured to eject the harvested material into a loading container. For the variable acceleration of the harvested material, the width of a harvested material passage gap of the post-acceleration unit may be adjusted using a gap-changing device. Specifically, a control device, which may be associated with the gap-changing device, may be configured to control the gap-changing device using a generated control signal (e.g., at least one command or control signal that is transmitted wired and/or wirelessly). In one or some embodiments, the control device is configured to receive and evaluate data generated by a swath detection device arranged or positioned on the harvester. In one or some embodiments, the data comprise one or more properties of the harvested material to be picked up by the harvester in the form of a swath, and to generate the control signals for adjusting the width of the harvested material passage gap depending on the evaluation of the data of the swath detection device. In one or some embodiments, the evaluation of the data may comprise determining one or both of: at least one property of the harvested material; or at least one property of harvested material throughput.

Thus, detecting early on irregularities in the harvested material deposited in the form of the swath in the forefield area of the harvesting machine may enable the harvester to react more promptly (e.g., with greater foresight), to changing harvesting conditions and/or harvesting situations. The swath may be deposited in a preceding cultivation process during which irregularities may occur while depositing due to various influences. For example, fluctuations in the crop density, damage to the implement used for swathing and/or operating errors occurring during swathing may lead to such irregularities. Weather conditions may have a further influence both during and after swathing as well as during the pick-up of the swath by the harvesting machine configured for this purpose.

In particular, the risk of blockages occurring that are caused by uneven swaths or an uneven harvested material mass of the swaths to be picked up or collected may be avoided or at least reduced or minimized by the actuation as disclosed. For example, if unevenness of the swath is detected, the width of the harvested material passage gap may be changed early on responsive to detecting the unevenness of the swath. This may prevent disruptions in the crop flow and therefore downtimes for clearing blockages in the interior of the harvester.

In one or some embodiments, the width of the harvested material passage gap of the post-acceleration unit refers to the distance between the post-acceleration unit and a wall of a conveying channel of the harvester opposite thereto.

In one or some embodiments, the control device may be part of a control and regulation unit of the harvester, which may perform one or more additional tasks, or may be designed as a separate control unit that is connected to a higher-level control and regulation unit of the harvester.

In one or some embodiments, the swath detection device may be equipped with at least one optical sensor for detecting a forefield area. The at least one sensor may be configured to detect the presence and/or a shape of the swath in front of the harvester. The swath detection device may transmit this data to the control device for the control device to evaluate the data (and control the width responsive to the evaluation). The at least one optical sensor may be any one, any combination, or all of: a camera; an RGB camera; a 3D camera; or a LIDAR. One or more aspects of the shape of the swath are contemplated, including any one, any combination, or all of: the width; the height; and the contour. The shape of the swath may provide information about the uniformity of the distribution and/or the amount of harvested material to be picked up. The presence of the swath may be used to detect changes in the harvesting situation. For example, a gap in the swath may lead to a temporary reduction in the amount of crop to be transferred, which may be responded to by changing the width of the harvested material passage gap. An implemented change may only last for the period or the distance until the end of the gap is reached. Another change to the harvesting situation may be when the headland is reached, during which no crop is picked up. Again, responsive to detecting the headland, the control device may modify the width for the period or the distance until the end of the detected headland.

In particular, the control device may be configured to infer, deduce, or determine a harvested material throughput quantity based on the shape of the swath. For this purpose, an image processing system may be provided which may interact with (e.g., be in communication with) the control device or may be a component of the control device.

In one or some embodiments, the swath detection device may be equipped with at least one sensor arranged or positioned along the harvested material flow, which may detect one or more properties of the harvested material. The swath detection device may be configured to transmit (e.g., wired and/or wirelessly) this data to the control device. The at least one sensor configured to detect harvested material properties may be an NIR sensor and/or a moisture sensor. The arrangement along the harvested material flow may be anywhere within the harvester. In one or some embodiments, the at least one sensor may be provided or positioned on the transfer device. While the moisture sensor may only detect the moisture of the harvested material, an NIR sensor may detect additional information on the properties of the harvested material.

In particular, the swath detection device may be designed with at least one sensor array which may be configured to detect a layer height in the intake unit. The swath detection device may transmit the data on the layer height determined by the at least one sensor array to the control device to determine a harvested material throughput. The at least one sensor array may be configured to detect forces that are applied to the picked-up harvested material by at least one pair of rollers of an intake unit connected upstream from the post-acceleration unit. Additionally or alternatively, the at least one sensor array may be configured to detect a deflection of a pair of rollers or of the pairs of rollers of the intake unit. The at least one sensor array, which may additionally be configured to determine the harvested material throughput, may improve the accuracy of the determination of the harvested material throughput, whereby a more precise actuation for adjusting the width of the harvested material passage gap may be made possible by the control device.

In one or some embodiments, the control device may be configured to access a memory unit (e.g., a memory unit external to the control device or a memory unit within the control device) in which a relative or absolute threshold value for a change in the harvested material throughput is saved. The control device may be configured to use the relative or absolute threshold value in order to determine whether/how to adjust the width of the harvested material gap. For example, responsive to the control device automatically determining exceeding of the relative or absolute threshold value, the control device may interpret this as an indicator for adjusting the width of the harvested material passage gap. Such a threshold value may be provided in order to avoid overregulation of the gap-changing device due to only minor deviations in the shape of the swath, which may have an undesirable effect on the harvested material flow and the transfer process.

In one or some embodiments, the post-acceleration unit may have an axle which is mounted at the end in guides which may be arranged or positioned on side walls which delimit a housing which at least partially encloses the post-acceleration unit. The gap-changing device may comprise one or more actuators for movement (such as translatory movement) of the post-acceleration unit, through which the width of the harvested material passage gap may be changed. A pivoting movement of the post-acceleration unit is also contemplated in order to change the width of the harvested material passage gap. In this regard, various movement may be performed in order to modify the width of the harvested material passage gap.

For this purpose, the one or more actuators may comprise any one, any combination, or all of mechanically, hydraulically, or electromechanically actuatable drive elements. In one or some embodiments, at least one hydraulically and/or electromechanically actuatable drive element may be at least one hydraulic cylinder or at least one linear motor, for example. Further, in one or some embodiments, at least one lever arrangement and a shaft or spindle may be provided as mechanically actuatable drive elements, for example. The at least one hydraulically and/or electromechanically actuatable drive element may act on the shaft at a first pivot point and pivot it about a fixed axis of rotation. The at least one lever arrangement may act on the shaft at a second pivot point at a distance from the first pivot point, so that the movement of the hydraulically and/or electromechanically actuatable drive element is transmitted to the lever arrangement. The first pivot point and the second pivot point may be arranged or positioned at opposite points on the shaft. Furthermore, two spindles connected via a connecting link may be used for adjustment.

In one or some embodiments, a sensor assigned to the post-acceleration unit and/or the actuators transmits the respective manipulated variable to the control device.

In one or some embodiments, the gap-changing device may have an adjustment characteristic with an essentially (e.g., at least 80%, at least 85%, at least 90%, at least 95%, at least 96%, at least 97%, at least 98%, at least 99%) progressively rising curve of the adjustment of the width of the harvested material passage gap. The advantage of such a gap-changing device may be that when setting small distance values for the width of the harvested material gap, a very precise adjustment is made possible by the gap-changing device, while with the setting of increasing distance values for the width, the change may be achieved more quickly by actuating the gap-changing device. The former may be relevant for dry harvested material and/or low harvested material throughputs which may be due, for example, to an irregularity in the shape of the swath, a gap in the swath or cutting or reaching a headland. The latter may be relevant for substantially uniform, larger harvested material throughputs in order to optimize the power consumption of the post-acceleration unit.

In one or some embodiments, the gap-changing device may be configured to adjust the width of the harvested material passage gap to a minimum value of 2 mm and/or up to a maximum value of 80 mm. The minimum value for the width of the harvested material passage gap may result in maximum acceleration of the harvested material at a given drive speed of the post-acceleration unit. In particular, the gap-changing device may be configured to smoothly adjust the width of the harvested material passage gap.

In one or some embodiments, at least one characteristic curve (such as a family of characteristic curves) for the width of the harvested material passage gap to be set may be saved in the memory unit depending on at least one property of the harvested material and/or the harvested material throughput. The control device may comprise a computing unit which is configured to automatically evaluate the at least one characteristic curve (e.g., the at least one family of characteristic curves) to control the gap-changing device. At least the data provided by the swath detection device may form input variables, and the gap width to be set may form the output variable. In one or some embodiments, the swath detection device may include one or more sensors. For example, data from the at least one sensor, which may be configured to detect properties of the harvested material, and/or from the at least one sensor array, which may be used to draw conclusions about the harvested material throughput, may form additional input variables.

In particular, the control device may be configured to control the gap-changing device in such a way as to modify the width (e.g., reduce the width) of the harvested material passage gap as the harvested material becomes drier and/or the harvested material throughput decreases. Increasing dryness and/or a decrease in the harvested material throughput require a reduction in the width of the harvested material passage gap in order to ensure safe transferring into the loading container. In this regard, the control device may evaluate the data in order to determine one or both of: that the harvested material is drier; or that harvested material throughput has decreased; and responsive to determining one or both of that the harvested material is drier or that the harvested material throughput has decreased, the control device may send one or more commands in order to reduce the width of the harvested material passage gap.

In particular, the control device may be configured to automatically control the gap-changing device. For example, the control device may: automatically evaluate one or both of: at least one aspect of the harvested material; or at least one aspect of harvested material throughput; automatically determine whether to modify the width of the harvested material passage gap; and responsive to automatically determining to modify the width of the harvested material passage gap, automatically actuate the gap-changing device. This may relieve the operator of the harvesting machine. In addition, automation may enable more timely and precise control and adjustment of the width of the harvested material passage gap in order to make the operation of the post-acceleration unit efficient.

In one or some embodiments, a method for operating a self-propelled agricultural harvester, such as a forage harvester, is disclosed. The harvester includes at least one post-acceleration unit for the variable acceleration of harvested material and with a transfer device arranged or positioned downstream from the post-acceleration unit for ejecting the harvested material into a loading container. Further, the width of a harvested material passage gap of the post-acceleration unit may be adapted using a gap-changing device for the variable acceleration of the harvested material, wherein the gap-changing device is controlled by control signals generated by a control device. Thus, the control device may: receive the data generated by the swath detection device; evaluate the data generated by the swath detection device that is indicative of the one or more properties of the harvested material to be collected by the harvester in the form of the swath; generate, based on evaluating the data, the at least one control signal indicative of adjusting the width of the harvested material passage gap; and transmit, to the gap-changing device, the at least one control signal in order to control the width of the harvested material passage gap. In turn, the gap-changing device may control the width of the harvested material passage gap based on the at least one control signal.

Thus, in one or some embodiments, the control device receives and evaluates data generated by a swath detection device, which data may comprise one or more properties of the harvested material to be picked up by the harvester in the form of a swath, and that the control device generates the control signals for adjusting the width of the harvested material passage gap depending on the evaluation of the data provided by the swath detection device. The method is distinguished by the fact that the post-acceleration unit may be operated more efficiently. The risk of blockages occurring in the conveying channel may be avoided or at least reduced. This may be accompanied by the avoidance of downtimes that have to be spent on removing such blockages.

The fast setting of large distance values for the width of the harvested material passage gap may be relevant in order to be able to react to a sudden increase in harvested material throughput, as may occur shortly after entering the field, and to optimize energy consumption.

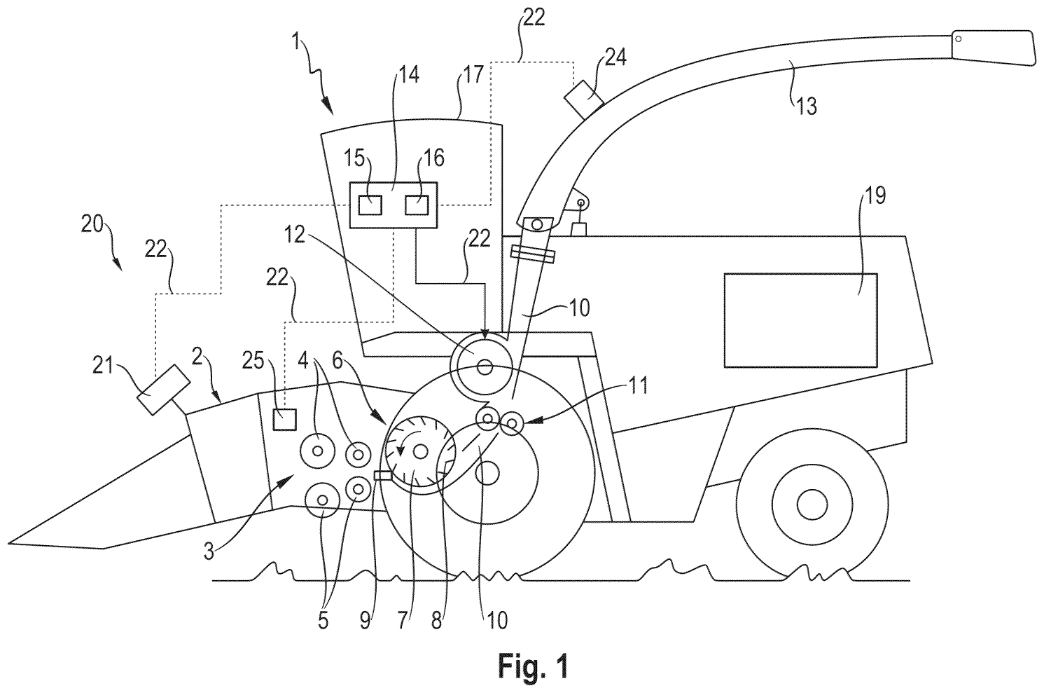

Referring to the figures, FIG. 1 shows a self-propelled agricultural harvester 1 designed as a forage harvester, on which an attachment 2 is arranged or positioned in the front area for picking up or collecting harvested material deposited on the ground. The front attachment 2 may vary depending on the type of harvested material to be harvested or picked up. The attachment 2 may pick up the harvested material from the field and convey it to an intake unit 3, which in the illustrated embodiment comprises (or consists of) a roller group with upper and lower feed rollers 4, 5. The feed rollers 4, 5 of the intake unit 3 may exert a pressing force on the collected harvested material. The intake unit 3 may convey the harvested material compacted into a harvested material mat to a chopping device 6, which may have a rotatingly driven cutterhead 7 with chopping blades 8 distributed around its circumference. The chopping blades 8 may cut the harvested material mat fed by the intake unit 3 against a shear bar 9. The cut or chopped harvested material may be conveyed by the rotary movement of the cutterhead 7 into a downstream conveying channel 10, from where, depending on the equipment of the forage harvester 1, it may be processed by an optional post-processing device 11, also known as a conditioning device or corncracker, arranged or positioned in the crop flow path, and may be conveyed by a downstream, rotationally driven post-acceleration unit 12, additionally accelerated by an adjustable transfer device 13, into an accompanying transport vehicle (e.g., a vehicle that accompanies, such as drives alongside and/or behind the forage harvester 1). Examples of a post-acceleration unit 12 are disclosed in US Patent Application Publication No. 2019/0261561 A1, US Patent Application Publication No. 2023/0060670 A1, and U.S. Pat. No. 9,706,712 B2, each of which are incorporated by reference herein in their entirety. The optional post-processing device 11 may either be swung out of the crop flow path or removed completely. The transfer device 13 may be rotated about a vertical axis, for example using a slewing ring. In addition and independently of this, the transfer device 13 may be pivoted about a horizontal axis. A so-called ejection flap may be arranged or positioned at the free end of the transfer device 13, which may be pivoted about a horizontal axis relative to the transfer device 13.

In one or some embodiments, a drive motor 19 is provided and configured to drive the working unit(s) of the harvester 1 (e.g., any one, any combination, or all of the attachment 2, intake unit 3, chopping device 6, the post-processing device 11, and the post-acceleration unit 12). The working units may be connected to the motor output shaft of the drive motor 19 by a main drive train (not shown). The drive motor 19 may also serve to operate a hydrodynamic drive of the forage harvester 1.

The harvester 1 may comprise a driver's cab 17 in which an input/output unit 18 (e.g., a touchscreen) is arranged. Furthermore, the harvester 1 may comprise a control device 14, which may comprise a memory unit 15 (an example of a memory) for storing data and a computing unit 16 for processing the data saved in the memory unit 15. In one or some embodiments, computing unit 16 may comprise at least one processor, such as a microprocessor, controller, PLA, or the like. Similarly, the memory unit 15 may comprise any type of storage device (e.g., any type of memory). Though the computing unit 16 and the memory unit 15 are depicted as separate elements, they may be part of a single machine, which includes a microprocessor (or other type of controller) and a memory. Alternatively, the computing unit 16 may rely on the memory unit 15 for all of its memory needs. In one or some embodiments, the memory unit 15 may comprise a tangible computer readable storage medium that stores a computer program comprising instructions which, when the instructions are executed by the computing unit 16, cause the control device 14 to perform any one, any combination, or all of the functions described herein by the control device 14.

The computing unit 16 and the memory unit 15 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the control device 14 is configured to support an operator of the harvester 1 in operating it. The control device 14 is configured to automatically control at least the post-acceleration unit 12.

A swath detection device 20 is arranged or positioned on the harvester 1. The swath detection device 20 may be equipped with at least one optical sensor 21 configured to detect a forefield area (e.g., a section located in front of the harvester 1 in the direction of travel). The at least one optical sensor 21 is configured to detect one or more aspects of the swath 23, such as the presence and/or a shape of a swath 23 in front of the harvester 1. The swath detection device 20 may transmit data determined or generated by the at least one optical sensor 21 that is indicative of the presence and/or a shape of a swath 23 in front of the harvester 1 to the control device 14 for evaluation. For this purpose, the at least one optical sensor 21 may be connected to the control device 14 via a bus system 22 of the harvester 1. Alternatively, or in addition, the at least one optical sensor 21 may wirelessly communicate with the control device 14. The at least one optical sensor 21 may be designed as a camera, RGB camera, 3D camera or LIDAR.

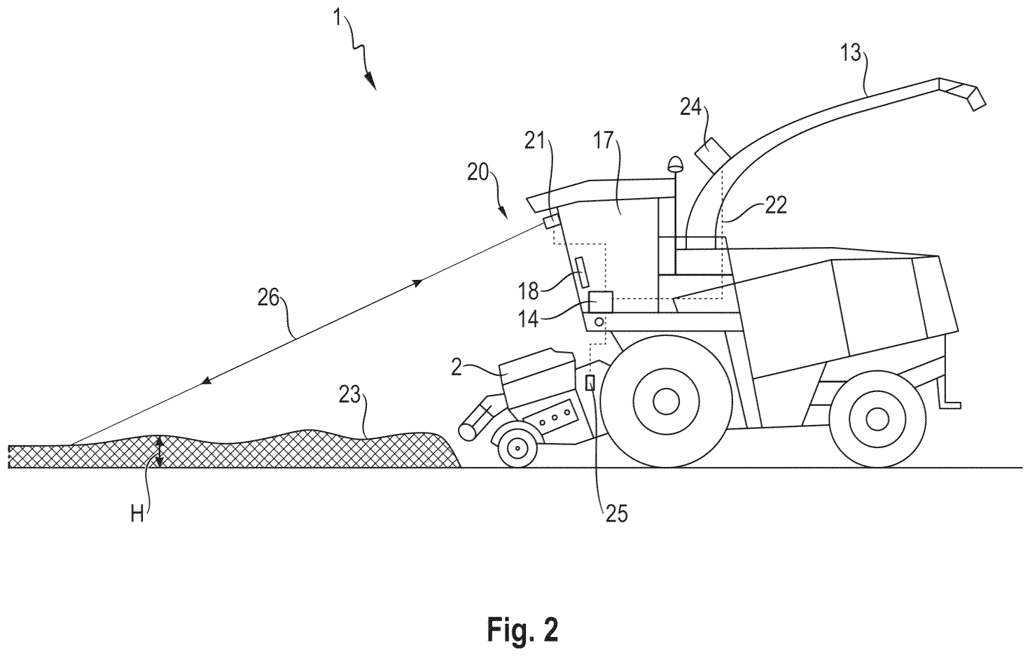

The illustration in FIG. 1 shows an exemplary arrangement of the at least one optical sensor 21 directly on the attachment 2. FIG. 2 shows an alternative arrangement on the driver's cab 17.

Furthermore, the swath detection device 20 may be equipped with at least one sensor 24 arranged or positioned along the harvested material flow which is configured to detect one or more properties of the picked-up harvested material. The swath detection device 20 may also transmit (wired and/or wirelessly) this data to the control device 14 for evaluation. The at least one sensor 24 arranged or positioned along the harvested material flow may be an NIR sensor and/or a moisture sensor. The arrangement of the at least one sensor 24 along the harvested material flow may be at any position within the harvester 1. In one or some embodiments, the at least one sensor 24 may be provided or positioned on the transfer device 13. While a moisture sensor is configured to only detect the moisture of the harvested material, an NIR sensor may detect additional information about the properties of the harvested material.

Furthermore, the swath detection device 20 may be designed with at least one sensor array 25, which may be configured to detect a layer height in the intake unit 3. Using the data generated by the sensor array 25, the presence of harvested material and the throughput of harvested material may be determined.

FIG. 2 shows a schematic representation of the harvester 1 according to FIG. 1 with an attachment 2 designed as a pick-up for picking up the swath 23. The at least one optical sensor 21 arranged or positioned on the driver's cab 17 may use one or more scanning beams 26 in order to generate data to detect one or more aspects of the swath, such as the presence of the swath 23 and/or its geometry and/or shape with which the swath 23 was deposited on the ground in a preceding process. As may be seen from the illustration in FIG. 2, the swath 23 generally has an irregular height contour H. The height contour H may change along the swath 23 depending, among other things, on the crop density of the previously harvested material. Other influences may result from the preceding process of forming the swath 23.

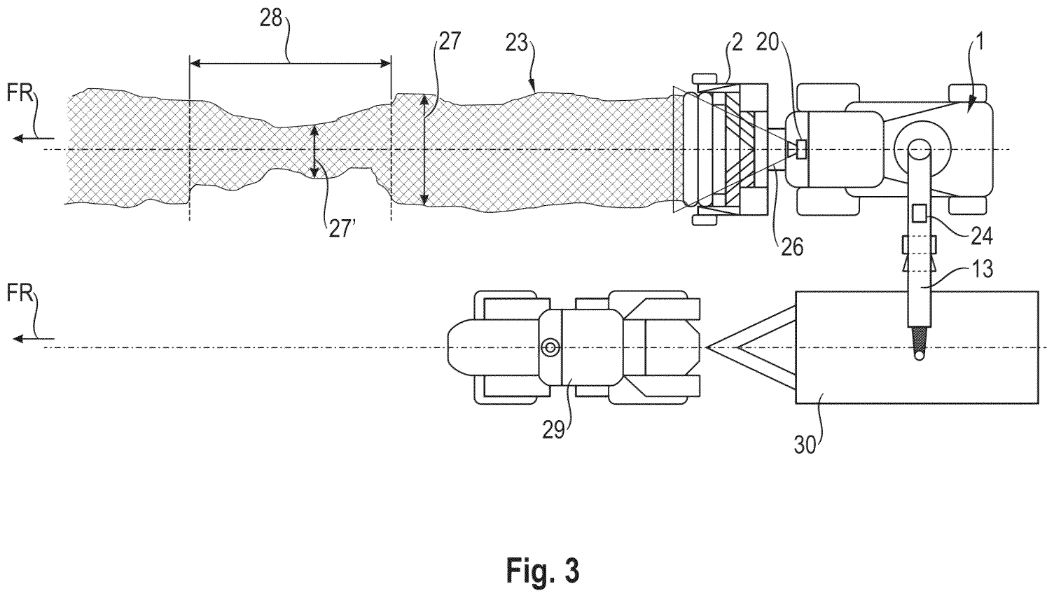

The illustration in FIG. 3 illustrates a schematic view of a harvesting situation of the harvester according to FIG. 2 from above. The harvester 1 may be accompanied by a towing vehicle 29 and a loading container 30 attached thereto, which may drive in a lane essentially parallel to the harvester 1 or in the lane behind the harvester 1 for transferring, depending on the harvesting situation.

The swath 23 not only may have an irregular height contour H, but may also vary to varying degrees in its width 27. 28 denotes a section along the swath 23 to be picked up which may have a smaller width 27′ than the preceding section or a subsequent section due to a lower crop density of harvested material.

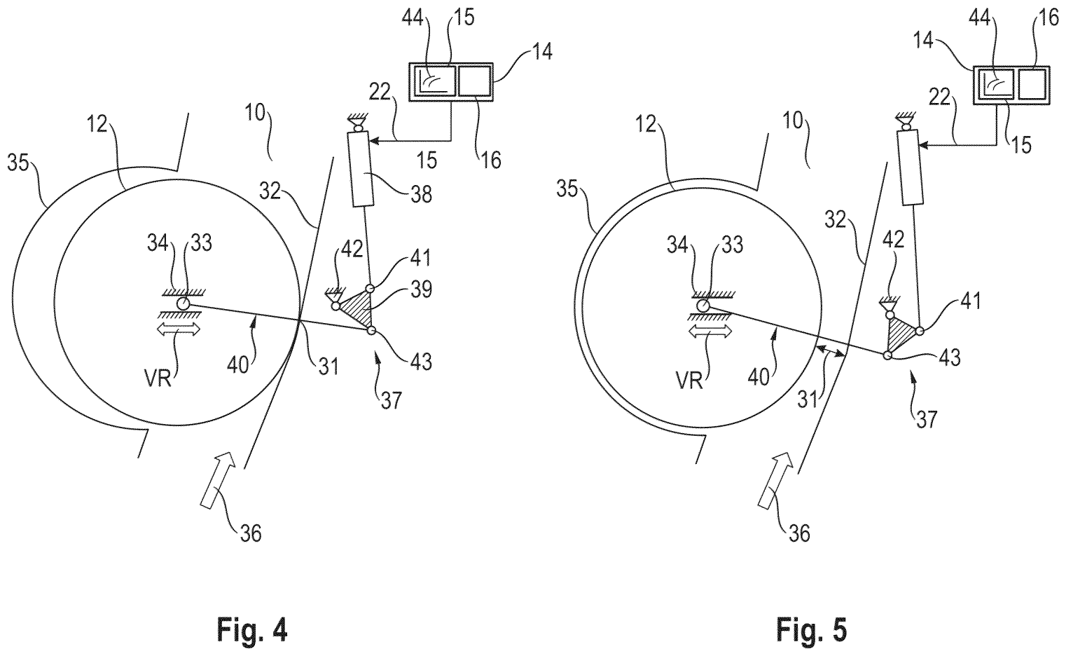

FIG. 4 illustrates a schematic and exemplary side view of a post-acceleration unit 12 of the harvester 1 in a position with minimum width of a harvested material passage gap 31. In FIG. 4, the minimum adjustable width of the adjustable harvested material passage gap 31 may be approximately 2 mm.

The illustration in FIG. 5 shows a schematic and exemplary side view of the post-acceleration unit 12 according to FIG. 4 in a position with maximum width of the harvested material passage gap 31. In FIG. 5, the maximum adjustable width of the adjustable harvested material passage gap 31 may be exactly or approximately 80 mm. In one or some embodiments, approximately may comprise at least 90%, at least 95%, at least 96%, at least 97%, at least 98%, or at least 99%.

In one or some embodiments, the width of the adjustable harvested material passage gap 31 of the rotationally driven post-acceleration unit 12 may denote the distance between the post-acceleration unit 12 or its enveloping circle and a wall 32 of the conveying channel 10 of the harvester 1 opposite thereto.

The post-acceleration unit 12 may have an axis of rotation 33, which may be displaceably mounted at the end in guides 34, as illustrated by the arrow VR. The guides 34 may be arranged or positioned on side walls, which may delimit a housing 35 at least partially encasing the post-acceleration unit 12. The side walls may be part of the housing 35.

For variable acceleration of the harvested material conveyed along the conveying channel 10 (arrow 36), the width of the harvested material passage gap 31 of the post-acceleration unit 12 may be adjusted using a gap-changing device 37. The gap-changing device 37 may be associated with the control device 14 (e.g., under the control or command of the control device 14), which may be configured to automatically control the gap-changing device 37 using one or more control signals generated by the control device 14.

According to the depicted embodiment, the gap-changing device 37 may comprise one or more actuators for the movement, such as translatory movement, (arrow VR) of the post-acceleration unit 12, through which the width of the harvested material passage gap 31 may be changed. By changing the width of the harvested material passage gap 31, it is possible to react to different operating situations in which a different acceleration of the harvested material by the post-acceleration unit 12 may be required.

In one or some embodiments, the one or more actuators of the gap-changing device 37 comprise any one, any combination, or all of mechanically, hydraulically, or electromechanically operable drive elements. See elements 38, 39, 40. In the depicted embodiment, the gap-changing device 37 may comprise at least one hydraulic cylinder 38, a shaft 39, and at least one lever arrangement 40 as operable drive elements. Alternatively, a spindle may be provided instead of the shaft 39. It is also contemplated for two spindles connected via a connecting link to be used for adjustment.

The at least one hydraulically and/or electromechanically actuatable drive element, which may comprise the at least one hydraulic cylinder 38, may act on the shaft 39 at a first pivot point 41 and may pivot it about a stationary axis of rotation 42. The lever arrangement 40 may act on the shaft 39 at a second pivot point 43 at a distance from the first pivot point 41 so that the movement of the at least one hydraulic cylinder 38 may be transferred to the at least one lever arrangement 40. The first pivot point 41 and the second pivot point 43 may be arranged or positioned at opposite points on the shaft 39. In one or some embodiments, two hydraulically and/or electromechanically actuatable drive elements, which may comprise the two hydraulic cylinders 38 arranged or positioned at a distance from one another may be provided and may act on the shaft 39 in its end regions. The provision of two hydraulically and/or electromechanically actuatable drive elements may enable a more uniform adjustment of the shaft 39.

The retraction of the piston rod of the at least one hydraulic cylinder 38 may cause the shaft 39 to rotate or pivot counterclockwise, whereby the axis of rotation 33 of the post-acceleration unit 12 may be moved in the direction of the wall 32 of the conveying channel 10 until the minimum adjustable width of the harvested material passage gap 31 is reached, as shown in FIG. 4.

The extension of the piston rod of the hydraulic cylinder 38 may cause the shaft 39 to rotate or pivot clockwise, whereby the axis of rotation 33 of the post-acceleration unit 12 may be increasingly spaced from the wall 32 until the maximum adjustable width of the harvested material passage gap 31 is reached, as shown in FIG. 5.

In one or some embodiments, the gap-changing device 37 has an adjustment characteristic with an essentially progressively rising curve of the adjustment of the width of the harvested material passage gap 31. The advantage of a gap-changing device 37 designed in this way is that with a setting of small distance values, such as less than or equal to 30 mm, for the width of the harvested material passage gap 31, very precise setting may be made possible by the gap-changing device 37, while with the setting of increasing distance values, such as greater than 30 mm, for the width, the change may be achieved more quickly by controlling the gap-changing device 37. A precise setting of small distance values for the width of the harvested material passage gap 31 may be relevant for dry harvested materials and/or for low harvested material throughputs. The precise setting of small distance values for the width of the harvested material passage gap 31 may enable optimum acceleration and more energy-efficient operation of the post-acceleration unit 12 for dry harvested material and/or low harvested material throughput. The fast setting of large distance values for the width of the harvested material passage gap 31 may be relevant in order to be able to react to a sudden increase in harvested material throughput, as may occur shortly after entering the crop (e.g., entering the portion of the field containing crop), and to optimize energy consumption.

The memory unit 15 may store at least one characteristic curve 44 (such as a single characteristic curve or a family of characteristic curves) for the width of the harvested material passage gap 31 to be set depending on at least one feature of the harvested material and the harvested material throughput. The computing unit 16 of the control device 14 may access and/or evaluate the at least one characteristic curve 44 or the at least one family of characteristic curves for controlling the gap-changing device 37.

Furthermore, a relative or absolute threshold value for a change in the harvested material throughput may be saved in the memory unit 15. Responsive to a determination by the control device 14 that the relative or absolute threshold value is exceeded, the control device 14 may interpret this as an indicator or a trigger to responsively adjust the width of the harvested material passage gap 31. Such a threshold value may be provided to avoid overregulation of the gap-changing device 37. In this way, it may be avoided that, due to only minor deviations in the shape of the swath and an associated change in the harvested material throughput, the gap-changing device 37 is activated in order to react to this change.

In particular, the control device 14 may be configured to control the gap-changing device 37 in such a way as to reduce the width of the harvested material passage gap 31 as the harvested material becomes drier and/or the harvested material throughput decreases. Increasing dryness and/or a decrease in the harvested material throughput may necessitate a reduction in the width of the harvested material passage gap 31 in order to ensure safe transferring into the loading container 30.

In one or some embodiments, the control device 14 is configured to automatically control the gap-changing device 37. In conjunction with the data that is generated by the swath detection device 20, the gap-changing device 37 may be controlled automatically in order to operate the post-acceleration unit 12 efficiently. The adjustment characteristic of the gap-changing device 37, which may have an essentially progressively rising characteristic, may enable improved adaptation to different harvesting conditions and/or harvested material properties. A more sensitive and precise adjustment of small distance values for the width of the harvested material passage gap 31 when the harvested material throughput is low and/or the harvested material is dry contrasts with an increasingly faster adjustment of distance values for the width of the harvested material passage gap 31 when the harvested material throughput increases disproportionately. A disproportionate increase occurs, for example, after starting to cut or reentering the crop after passing through a headland.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

| | |
|---|---|
| 1 | Harvester |
| 2 | Attachment |
| 3 | Intake unit |
| 4 | Upper feed rollers |
| 5 | Lower feed rollers |
| 6 | Chopping device |
| 7 | Cutterhead |
| 8 | Chopping blade |
| 9 | Shear bar |
| 10 | Conveying channel |
| 11 | Post-processing device |
| 12 | Post-acceleration unit |
| 13 | Transfer device |
| 14 | Control device |
| 15 | Memory unit |
| 16 | Computing unit |
| 17 | Driver's cab |
| 18 | Input/output unit |
| 19 | Drive motor |
| 20 | Swath detection device |
| 21 | Sensor |
| 22 | Bus system |
| 23 | Swath |
| 24 | Sensor |
| 25 | Sensor assembly |
| 26 | Scanning beams |
| 27 | Width |
| 27′ | Width |
| 28 | Section |
| 29 | Towing vehicle |
| 30 | Loading container |
| 31 | Harvested material passage gap |
| 32 | Wall |
| 33 | Axis of rotation |
| 34 | Guide |
| 35 | Housing |
| 36 | Harvested material |
| 37 | Gap-changing device |
| 38 | Drive element/hydraulic cylinder |
| 39 | Drive element/shaft |
| 40 | Drive element/lever arrangement |
| 41 | First pivot point |
| 42 | Stationary axis of rotation |
| 43 | Second pivot point |
| 44 | Characteristic |
| FR | Driving direction |
| H | Height contour |
| VR | Movement (arrow) |

1. A self-propelled agricultural harvester comprising:
at least one post-acceleration unit configured for variable acceleration of harvested material, the at least one post-acceleration unit comprising a harvested material passage gap, a width of the harvested material passage gap being adjustable using a gap-changing device for variable acceleration of the harvested material;
a transfer device positioned downstream from the at least one post-acceleration unit and configured to eject the harvested material into a loading container;
a swath detection device positioned on the harvester and configured to generate data indicative of one or more properties of the harvested material to be collected by the harvester in a form of a swath;
a control device configured to control the gap-changing device using at least one control signal, wherein the control device is configured to:
receive the data generated by the swath detection device;
evaluate the data generated by the swath detection device that is indicative of the one or more properties of the harvested material to be collected by the harvester in the form of the swath;
generate, based on evaluating the data, the at least one control signal indicative of adjusting the width of the harvested material passage gap; and
transmit, to the gap-changing device, the at least one control signal in order to control the width of the harvested material passage gap.

2. The self-propelled harvester of claim 1, wherein the swath detection device comprises at least one optical sensor configured to detect a forefield area;
wherein the at least one optical sensor is configured to detect one or both of presence or shape of the swath in front of the harvester; and
wherein the swath detection device is configured to transmit the data that is indicative of the one or both of the presence or the shape of the swath.

3. The self-propelled harvester of claim 2, wherein the swath detection device is configured to transmit the data that is indicative of the shape of the swath;
wherein the control device is configured to: evaluate the data that is indicative of the shape of the swath in order to deduce a quantity of harvested material throughput; determine the width of the harvested material passage gap based on the quantity of the harvested material throughput; and generate the at least one control signal to adjust to the determined width of the harvested material passage gap.

4. The self-propelled harvester of claim 1, wherein the swath detection device comprises at least one sensor positioned along a harvested material flow and configured to detect one or more properties of the harvested material in the harvested material flow;
wherein the swath detection device is configured to transmit the data indicative of the one or more properties of the harvested material in the harvested material flow to the control device; and
wherein the control device is configured to: determine, based on the data indicative of the one or more properties of the harvested material in the harvested material flow, the width of the harvested material passage gap; and generate the at least one control signal to adjust to the determined width of the harvested material passage gap.

5. The self-propelled harvester of claim 1, further comprising an intake unit;
wherein the swath detection device comprises at least one sensor array that is configured to generate the data indicative of a layer height in the intake unit;
wherein the swath detection device is configured to transmit the data indicative of the layer height in the intake unit to the control device;
wherein the control device is configured to determine, based on the data indicative of the layer height in the intake unit, a harvested material throughput;
wherein the control device is configured to determine the width of the harvested material passage gap based on the harvested material throughput; and
wherein the control device is configured to generate the at least one control signal to adjust to the determined width of the harvested material passage gap.

6. The self-propelled harvester of claim 5, wherein the control device is configured to access a memory;
wherein the memory is configured to store a relative or absolute threshold value;
wherein the control device is configured to determine the width of the harvested material passage gap based on the harvested material throughput by:
comparing the harvested material throughput with the relative or absolute threshold value; and
based on the comparison, determining the width of the harvested material passage gap.

7. The self-propelled harvester of claim 1, wherein the post-acceleration unit has an axis of rotation which is mounted at at least one end in guides which are arranged on side walls which delimit a housing that at least partially encloses the post-acceleration unit; and
wherein the gap-changing device comprises one or more actuators for movement of the post-acceleration unit, through which the width of the harvested material passage gap is changed.

8. The self-propelled harvester of claim 7, wherein the movement of the post-acceleration unit comprises translatory movement.

9. The self-propelled harvester of claim 7, wherein the one or more actuators comprise one or more of mechanically, hydraulically, or electromechanically operable drive elements.

10. The self-propelled harvester of claim 1, wherein the control device is configured to use, in order to determine the width of the harvested material passage gap, an adjustment characteristic that correlates one or both of at least one property of the harvested material or at least one property of harvested material throughput with the width of the harvested material passage gap as an essentially progressively rising curve of adjustment of the width of the harvested material passage gap.

11. The self-propelled harvester of claim 10, wherein the gap-changing device is configured to adjust the width of the harvested material passage gap to a minimum value of 2 mm up to a maximum value of 80 mm.

12. The self-propelled harvester of claim 10, wherein at least one characteristic curve for the width of the harvested material passage gap is saved in a memory accessible by the control device;
wherein the at least one characteristic curve correlates the one or both of the at least one property of the harvested material or the at least one property of the harvested material throughput; and
wherein the control device is configured to evaluate the data generated by the swath detection device using the at least one characteristic curve in order to generate the at least one control signal for controlling the gap-changing device.

13. The self-propelled harvester of claim 1, wherein the control device is configured to control the gap-changing device by:
evaluating the data in order to determine one or both of: that the harvested material is drier; or that harvested material throughput has decreased; and
responsive to determining one or both of that the harvested material is drier or that the harvested material throughput has decreased, reducing the width of the harvested material passage gap.

14. The self-propelled harvester of claim 1, wherein the control device is configured to:
automatically evaluate one or both of: at least one aspect of the harvested material; or at least one aspect of harvested material throughput;
automatically determine whether to modify the width of the harvested material passage gap; and
responsive to automatically determining to modify the width of the harvested material passage gap, automatically actuate the gap-changing device.

15. A method for operating a self-propelled agricultural harvester comprising:
using the self-propelled agricultural harvester, the self-propelled agricultural harvester including:
at least one post-acceleration unit configured for variable acceleration of harvested material, the at least one post-acceleration unit comprising a harvested material passage gap, a width of the harvested material passage gap being adjustable using a gap-changing device for variable acceleration of the harvested material;
a transfer device positioned downstream from the at least one post-acceleration unit and configured to eject the harvested material into a loading container;
a swath detection device positioned on the harvester and configured to generate data indicative of one or more properties of the harvested material to be collected by the harvester in a form of a swath;
receiving, by a control device, the data generated by the swath detection device;
evaluating, by the control device, the data generated by the swath detection device that is indicative of the one or more properties of the harvested material to be collected by the harvester in the form of the swath;
generating, by the control device based on evaluating the data, the at least one control signal indicative of adjusting the width of the harvested material passage gap;
transmitting, to the gap-changing device, the at least one control signal in order to control the width of the harvested material passage gap; and
controlling, by the gap-changing device the width of the harvested material passage gap based on the at least one control signal.

16. The method of claim 15, wherein the swath detection device comprises at least one optical sensor configured to detect a forefield area;
wherein the at least one optical sensor detects one or both of presence or shape of the swath in front of the harvester; and
wherein the swath detection device transmits the data that is indicative of the one or both of the presence or the shape of the swath.

17. The method of claim 16, wherein the swath detection device transmits the data that is indicative of the shape of the swath;
wherein the control device evaluates the data that is indicative of the shape of the swath in order to deduce a quantity of harvested material throughput, determines the width of the harvested material passage gap based on the quantity of the harvested material throughput, and transmits the at least one control signal to adjust to the determined width of the harvested material passage gap.

18. The method of claim 15, wherein the swath detection device comprises at least one sensor positioned along a harvested material flow and detect one or more properties of the harvested material in the harvested material flow;
wherein the swath detection device transmits the data indicative of the one or more properties of the harvested material in the harvested material flow to the control device; and
wherein the control device determines, based on the data indicative of the one or more properties of the harvested material in the harvested material flow, the width of the harvested material passage gap and generates the at least one control signal to adjust to the determined width of the harvested material passage gap.

19. The method of claim 15, wherein the self-propelled agricultural harvester further includes an intake unit;
wherein the swath detection device comprises at least one sensor array that generates the data indicative of a layer height in the intake unit;
wherein the swath detection device transmits the data indicative of the layer height in the intake unit to the control device;
wherein the control device determines, based on the data indicative of the layer height in the intake unit, a harvested material throughput;
wherein the control device determines the width of the harvested material passage gap based on the harvested material throughput; and
wherein the control device generates the at least one control signal to adjust to the determined width of the harvested material passage gap.

20. The method of claim 19, wherein the control device accesses a memory;
wherein the memory stores a relative or absolute threshold value;
wherein the control device determines the width of the harvested material passage gap based on the harvested material throughput by:
comparing the harvested material throughput with the relative or absolute threshold value; and
based on the comparison, determining the width of the harvested material passage gap.
